(19) United States
(12) Patent Application Publication
(10) Pub. No.: US 2026/0006034 A1
(43) Pub. Date: Jan. 1, 2026

(54) INSPECTING REQUESTS FOR SECRETS USED FOR AUTHENTICATIONS WITH RESOURCES BY AN INTERMEDIARY SERVER

(71) Applicant: CLOUDFLARE, INC., SAN FRANCISCO, CA (US)

(72) Inventor: Albert Lee Guinn, III, San Francisco, CA (US)

(21) Appl. No.: 18/757,127

(22) Filed: Jun. 27, 2024

(51) Int. Cl. H04L 9/40

(52) U.S. Cl. CPC H04L 63/108

(57) ABSTRACT

An intermediary server receives a first HTTP request from a client to access a resource hosted by a host server. The intermediary server can analyze the first HTTP request to identify a secret associated with the first HTTP request and apply a hashing algorithm to the identified secret to generate a hashed version of the identified secret. The intermediary server then updates a data structure with a client identifier associated with the first HTTP request, a resource identifier associated with the resource, the hashed version of the identified secret, and a time of the first HTTP request. The intermediary server then generates a dashboard interface based on data stored in the data structure, where the dashboard interface displays a history of requests for resources by clients.

### FIELD

Embodiments of the invention relate to the field of network communications, and more specifically, to using an intermediary server configured to inspect requests for resources to identify secrets used for authentications.

### BACKGROUND

Organizations often have computing infrastructures where applications and resources are distributed across multiple datacenters and devices. As organizations grow in size, the complexities of such infrastructures and the communications increase. To ensure data security, or to appropriately respond to security issues, such as breaches or leaks, organizations need a clear understanding of its security landscape.

### SUMMARY

An intermediary server receives an HTTP request from a client to access a resource hosted by a host server. The intermediary server analyzes the HTTP request to identify a secret associated with the HTTP request and apply a hashing algorithm to the identified secret to generate a hashed version of the identified secret. The intermediary server then updates a data structure with a client identifier associated with the HTTP request, a resource identifier associated with the resource, the hashed version of the identified secret, and a time of the HTTP request. The intermediary server then generates a dashboard interface based on data stored in the data structure, where the dashboard interface displays a history of requests for resources by clients.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary networked system according to some embodiments described herein;

FIG. 2 is a flow diagram that illustrates exemplary operations for inspecting requests for secrets used for authentications with resources by an intermediary server according to an embodiment; and

FIG. 3 illustrates a block diagram for an exemplary data processing system that can be used in some embodiments.

### DESCRIPTION OF EMBODIMENTS

Security incidents, such as data breaches or leaks, often require an organization to rotate secrets (e.g., authentication tokens, API keys, account credentials, security tokens, etc.). To ensure that all secrets are properly rotated, an organization needs insight into where all relevant secrets are.

In one embodiment, an intermediary server is situated within a networked environment to intercept traffic between applications, or traffic between a client device and an application. For example, an intermediary server receives requests (e.g., HTTP requests) from a client that are transmitted to access resources hosted by host servers. The intermediary server can decrypt and analyze the contents of received requests to identify attributes of the request including the client initiating the request, the requested resource, and a secret used for authenticating the client with the requested resource. The intermediary server uses the determined attributes of the request to generate an entry in a secrets usage data structure for the client-resource pair of the request. The entry in the secrets usage data structure correlates a time of the request with the secret presented for authentication, which can be used to generate an inventory of all secrets used by client applications and/or client devices of an organization.

Responding to a security incident often requires secret rotation. In conventional systems, security officers manually maintain a spreadsheet of secrets that are used and/or must manually search through source code of the organization's application software to determine secrets being used. This information is then used to rotate the appropriate secrets. However, as organizations can include thousands of disparate systems, this process can be time and resource-intensive, and can often result in some secrets being overlooked and not rotated, further exacerbating the consequences of a security incident. The embodiments described herein provide mechanisms for inspecting requests to identify and log the use of secrets by each particular client with each particular resource.

Embodiments of the invention provide many technical advantages, in addition to addressing the deficiencies of previous solutions. For example, improvements to the security of resources can be realized by automatically providing an inventory of existing secrets associated client applications and/or client devices of an organization. In addition to providing an inventory of secrets used by clients in an organization, this information can be used to determine whether a particular secret is stale, whether a particular secret has been in use for a period of time longer than a maximum time limit established by a customer policy, etc.

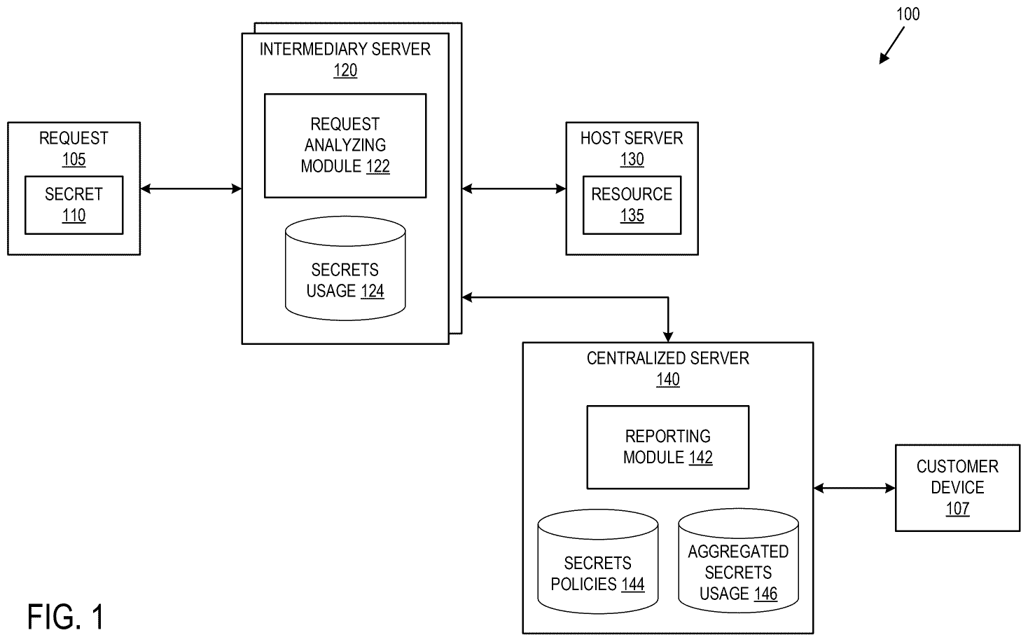

FIG. 1 illustrates an exemplary networked system according to some embodiments described herein. The exemplary networked system 100 illustrated in FIG. 1 includes an intermediary server 120 that operates as an intermediary device for requests directed to resources hosted by a host server 130. In some embodiments, the exemplary networked system 100 also includes a centralized server 140 that is connected to and/or in communication with the intermediary server 120.

The intermediary server 120 is configured to receive requests to access and/or modify resources hosted by the host server 130, and further configured to receive responses to such requests from the host server 130. For example, internet traffic (e.g., HTTP/S requests/responses) that is destined to an external destination such as the host server 130, is received at the intermediary server 120. As an example, the intermediary server 120 may function as a forward proxy that can receive internet traffic from clients that are configured to send traffic to the intermediary server 120. As another example, the intermediary server 120 may function as a reverse proxy that can receive internet traffic directed to the host server 130. Thus, the intermediary server 120 can receive traffic from multiple traffic sources (e.g., data centers, offices, devices, cloud properties) and route the traffic to its intended destination. The intermediary server 120 may be part of a distributed cloud computing network that includes multiple (e.g., hundreds or more) intermediary servers. Such intermediary servers may be distributed in different colocation centers (colos), data centers, and/or point-of-presences (PoP).

The embodiment depicted in FIG. 1 illustrates operations performed by the intermediary server 120 for managing a request 105 to access a resource 135 hosted by the host server 130, where the request 105 includes a secret 110 used to authenticate the request 105. Although a single host server is shown, the intermediary server 120 receives traffic for many different host servers.

The intermediary server 120 includes a request analyzing module 122 and databases, or data structures, including a secrets usage database 124. The secrets usage database 124 stores log data associated with requests that involve the use of secrets for accessing resources hosted by the host server 130. In some embodiments, each intermediary server 120 of a distributed cloud computing network can maintain a separate secrets usage database 124 that stores the information for requests received by the corresponding intermediary server 120 that involve the use of secrets for authentication. The secrets usage database 124 may store entries as client-resource pairs, where each client-resource pair corresponds to accesses to a particular resource by a particular client.

After the intermediary server 120 receives request 105, the request analyzing module 122 determines information from the request 105 including extracting a secret 110 if included in the request 105. The secret 110 can be an authentication token, an API key, account credentials, security tokens, etc. The request analyzing module 122 may identify a secret included in the request using pattern recognition. For example, the request analyzing module 122 can perform a pattern recognition process on an authorization header, a custom header for passing secrets, a query string of the request, the request body, or other parts of the request, to identify the secret(s) associated with the request 105. The pattern recognition can include a regex or series of regexes to identify a secret.

If a secret 110 is included in the request 105, the request analyzing module 122 hashes the extracted secret and generates an entry in the secrets usage database 124 for the request 105. The entry can include: a client identifier indicating a requesting client, a resource identifier associated with the resource 135 (e.g., a URI), a hashed version of the secret 110 used for the request, and a time of the first request.

If an entry already exists in the secrets usage database 124 for the client-resource pair, the request analyzing module 122 can update the entry in the secrets usage database 124. For example, the request analyzing module 122 can update a timestamp value associated with the client-resource pair indicating the most recent usage of the secret and/or increment a counter indicating the number of requests by the corresponding client for the resource.

In some embodiments, the secrets usage database 124 stores access log data associated with requests that involve the use of secrets for accessing resources as client-server pairs. In such embodiments, each entry for a client-server pair corresponds to accesses to a particular server by a particular client.

The intermediary server 120 periodically transmits secured usage information to the centralized server 140. The centralized server 140 is configured to receive configuration data from customer devices (e.g., customer device 107), enforce customer secrets policies, and generate reports and/or notifications based on secret usage information received from one or more intermediary servers 120. In some embodiments, the centralized server 140 includes a reporting module 142 and databases, or data structures, including a secrets policies database 144 and an aggregated secrets usage database 146. The secrets policies database 144 stores policies provided by a customer associated with a resource. For example, a customer secrets policy can define a length of time (e.g., 30 days, six months, etc.) that a secret can be used by a specific client for authentication with a specific resource. The secrets policies database 144 can receive the customer secrets policies from a customer device 107 as configuration data. The aggregated secrets usage database 146 stores aggregated log data associated with requests to access resources received from the one or more intermediary servers 120. In such embodiments, the one or more intermediary servers 120 can send periodic updates made to their secret usage databases 124 to the centralized server 140.

In some embodiments, the reporting module 142 can analyze the data in the aggregated secrets usage database 146 and perform actions based on customer secrets policies in the secrets policies database 144. For example, the customer secrets policies can define actions to be taken if an entry in the secrets usage database 124 indicates that a secret is stale (e.g., has not been used for longer than a customer-defined amount of time). In such embodiments, if an entry in the secrets usage database 124 indicates that a secret has been in use longer than a maximum time limit defined for usage of a secret or is stale, the reporting module 142 can generate an alert or notification that can be displayed in the customer device 107 indicating that the secret should be changed or rotated. In some embodiments, the alert or notification can be provided as an email, a webhook, an API call, or similar message types.

Examples of host server 130 includes computing devices that may serve and/or generate network resources (e.g., web pages, images, word processing documents, PDF files, movie files, music files, or other computer files). Host server 130 may also be an edge server to the server that serves and/or generates network resources. Although not illustrated in FIG. 1, it should be understood that the network resources of host server 130 may be stored separately from the device that responds to the requests.

Examples of customer device 107 include computing devices (e.g., laptops, desktops, workstations, smartphones, palm tops, mobile phones, tablets, gaming systems, set top boxes, wearable devices, internet-of-things (IoT) devices, electronic devices, etc.) that are capable of managing resources associated with the customer, including through the creation of customer secrets policies for such resources. The centralized server 140 can receive configuration data from the customer device 107. For example, the centralized server 140 may provide an interface that allows a user of the customer device 107 to provide the configuration data to configure settings and parameters for customer secrets policies that apply to resources hosted by the host server 130.

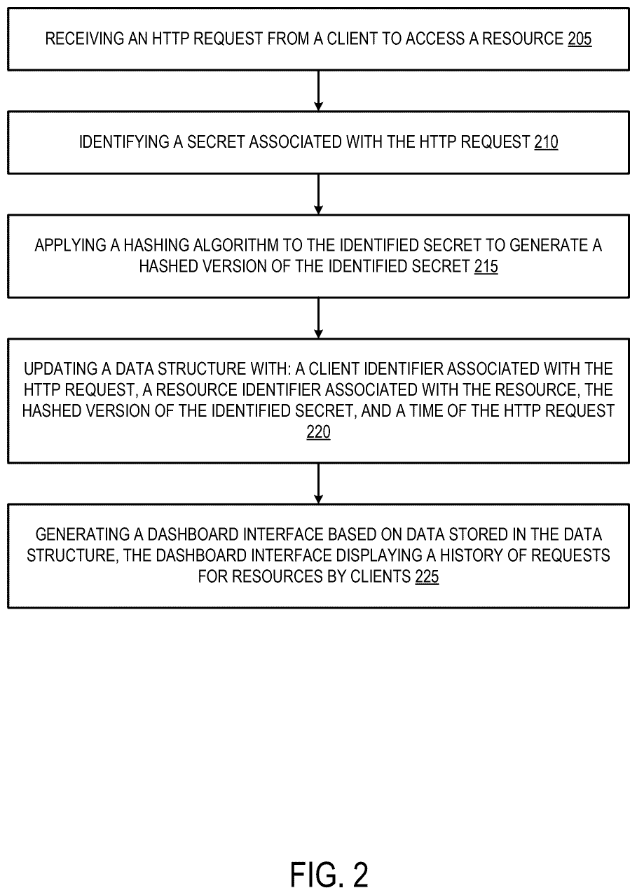

FIG. 2 is a flow diagram that illustrates exemplary operations for inspecting requests for secrets used for authentications with resources by an intermediary server according to an embodiment. The operations of FIG. 2 will be described with reference to the exemplary embodiment of FIG. 1. However, it should be understood that the operations of FIG. 2 can be performed by embodiments of the invention other than those discussed with reference to FIG. 1, and the embodiments discussed with reference to FIG. 1 can perform operations different than those discussed with reference to FIG. 2. The operations of FIG. 2 are described as being performed by an intermediary server (e.g., intermediary server 120).

In operation 205, an intermediary server receives a first HTTP request from a client to access a resource. The intermediary server 120 may be part of a distributed cloud computing network that includes multiple (e.g., hundreds or more) intermediary servers. The HTTP request can be a user-initiated request from a client device or a request from an automated system (e.g., an application-to-application request, a machine-to-machine request). The request may include a request for an action to be performed on the resource 135 hosted by a host server 130. The first HTTP request may include a secret (e.g., secret 110) for authenticating the client to access the resource 135.

In operation 210, the intermediary server identifies a secret associated with the first HTTP request. In some embodiments, the intermediary server 120 is a forward proxy that can decrypt the first HTTP request to analyze the contents of the first HTTP request. In some embodiments, the intermediary server 120 inspects the first HTTP request to identify a client identifier and a resource identifier associated with the resource. The resource identifier can be a uniform resource identifier (or URI). The intermediary server can further identify a secret to be used for authentication with the resource. The intermediary server 120 can identify the secret associated with the first HTTP request through a pattern recognition process on the first HTTP request. In some embodiments, the intermediary server 120 performs a pattern recognition process on an authorization header, a custom header for passing secrets, a query string of the request, the request body, or other parts of the request, to identify the secret(s) associated with the request 105. The pattern recognition can include a regex or series of regexes to identify a secret. Examples of the secret associated with the first HTTP request can include application programming interfaces (API) keys, service tokens, account credentials, etc.

In operation 215, the intermediary server applies a hashing algorithm to the identified secret to generate a hashed version of the identified secret. In embodiments, the hashing algorithm is a one-way deterministic hashing algorithm. In some embodiments, the intermediary server does not store the plain text version of the identified secret. Instead, the hashed version of the identified secret is stored that ensures that only an obfuscated version of the secret is stored.

In operation 220, the intermediary server updates a data structure with a client identifier associated with the first HTTP request, a resource identifier associated with the resource, the hashed version of the identified secret, and a time of the first HTTP request. In some embodiments, the intermediary server 120 includes a secrets usage database 124 that stores information for requests received by the intermediary server 120 as client-resource pairs. When the intermediary server 120 receives a request that does not have a client-resource pair as an entry in the secrets usage database 124, a new entry is made in the secrets usage database 124 with the client identifier, resource identifier, and timestamp. In some embodiments, the hashed version of the identified secret is appended to the entry in the secrets usage database 124. When the intermediary server 120 receives a request associated with a client-resource pair that has an existing entry in the secrets usage database 124, the request analyzing module 122 can update the existing entry instead of generating a new entry. For example, the request analyzing module 122 can update a timestamp value associated with the client-resource pair indicating the most recent usage of the secret and/or increment a counter indicating the number of requests by the corresponding client for the resource.

Including the timestamp of the first HTTP request with the entry in the secrets usage database 124 allows a time to be correlated with the usage of a particular secret. Providing an indication of the most recent time of usage of the secret for the client-resource pair can be used to identify any client-resource pairs that have a stale secret (e.g., a secret that has not been used for an extended period of time).

In some embodiments, the entry in the secrets usage database 124 for a client-resource pair can also include a second timestamp that can be used to store a time of the most recent rotation of a corresponding secret. This second timestamp can assist in determining which secrets should be rotated, and when they should be rotated.

In some embodiments, the intermediary server 120 can send the first HTTP request to the host server 130 prior to, concurrently, or subsequent to, updating the data structure with the information for the first HTTP request.

In operation 225, a centralized server generates a dashboard interface based on data stored in the data structure, the dashboard interface displaying a history of requests for resources by clients. In some embodiments, the centralized server 140 periodically receives data stored in the secrets usage database 124 from the intermediary server 120. The centralized server 140 then stores the data in an aggregated secrets usage database 146, which stores client-resource pair data from one or more intermediary servers 120. The centralized server 140 can apply customer secrets policies associated with the resource 135 based on the data in the aggregated secrets usage database 146. In one embodiment, the dashboard interface is periodically generated, e.g., based on customer-defined settings or preferences based on the data in the aggregated secrets usage database 146. In some embodiments, the dashboard interface is a user-interactable to allow a user to search where secrets are being used, identify secrets that are being used with multiple resources, identify secrets that are being used by multiple clients with a same resource, identify secrets that are stale, identify secrets that have not been seen (e.g., have not been to authenticate a client), etc. In some embodiments, the dashboard interface can display a list of the client-resource pairs with the least recent secret rotations to indicate to a customer the secrets that are the oldest in use.

In some embodiments, the dashboard interface can indicate secrets that should be rotated. For example, if a same secret is being used by multiple clients, the dashboard interface can include an alert or notification message associated with the client-resource pair to indicate that the secret may not be secure. In other embodiments, the dashboard interface can include an alert or notification message associated with client-resource pairs when a secret has been in use for longer than a maximum time limit for use of a secret before a rotation is required. In such embodiments, the centralized server 140 can access a secrets policies database 144 to determine an access policy corresponding to the client and/or resource. For example, an access policy in the secrets policies database 144 may require a secret be rotated every six months, after which a notification message is provided to a customer that the secret is due for rotation.

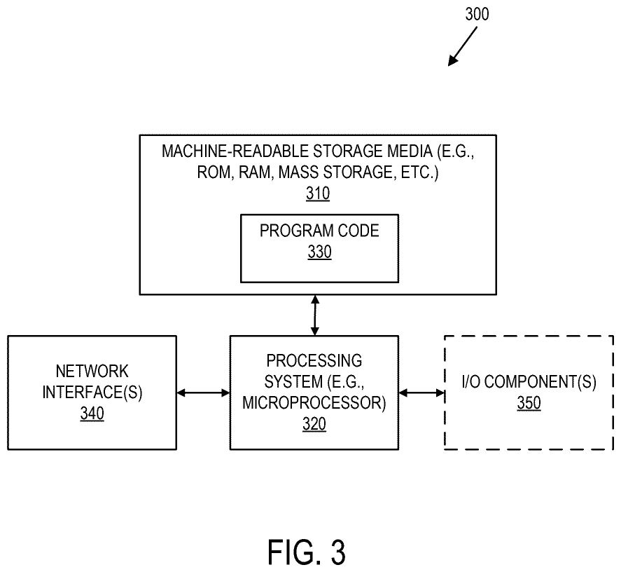

FIG. 3 illustrates a block diagram for an exemplary data processing system 300 that may be used in some embodiments. One or more such data processing systems 300 may be used to implement the embodiments and operations described with respect to the intermediary server, host server, or other electronic devices. The data processing system 300 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 310 (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals), which is coupled to the processing system 320 (e.g., one or more processors and connected system components such as multiple connected chips). For example, the depicted machine-readable storage media 310 may store program code 330 that, when executed by the processing system 320, causes the data processing system 300 to perform any of the operations described herein.

The data processing system 300 also includes one or more network interfaces 340 (e.g., a wired and/or wireless interfaces) that allows the data processing system 300 to transmit data and receive data from other computing devices, typically across one or more networks (e.g., Local Area Networks (LANs), the Internet, etc.). The data processing system 300 may also include one or more input or output (“I/O”) components 350 such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices.

Additional components, not shown, may also be part of the data processing system 300, and, in certain embodiments, fewer components than that shown in FIG. 3 may also be used in a data processing system 300. One or more buses may be used to interconnect the various components shown in FIG. 3.

Thus, an electronic device (e.g., a computer or a mobile client device) includes hardware and software, such as a set of one or more processors coupled to one or more machine-readable storage media to store code for execution on the set of processors and/or to store data. For instance, an electronic device may include non-volatile memory containing the code since the non-volatile memory can persist the code even when the electronic device is turned off, and while the electronic device is turned on that part of the code that is to be executed by the processor(s) of that electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

The techniques shown in the figures can be implemented using code and data stored and executed on one or more computing devices (e.g., client devices, servers, etc.). Such computing devices store and communicate (internally and/or with other computing devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals-such as carrier waves, infrared signals, digital signals, etc.). In addition, such computing devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given computing device typically stores code and/or data for execution on the set of one or more processors of that computing device. Of course, one or more parts of an embodiment of the invention may be implemented using different combinations of software, firmware, and/or hardware.

In the preceding description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the preceding description and the claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A computer-implemented method comprising:
receiving a first HTTP request from a client to access a resource;
identifying a secret associated with the first HTTP request;
applying a hashing algorithm to the identified secret to generate a hashed version of the identified secret;
updating a data structure with a client identifier associated with the first HTTP request, a resource identifier associated with the resource, the hashed version of the identified secret, and a time of the first HTTP request; and
generating a dashboard interface based on data stored in the data structure, the dashboard interface displaying a history of requests for resources by clients.

2. The computer-implemented method of claim 1, wherein identifying the secret associated with the first HTTP request comprises:
performing a pattern recognition on attributes of the first HTTP request, the attributes including an authorization header.

3. The computer-implemented method of claim 1, wherein updating the data structure further comprises:
generating an entry in the data structure for a client-resource pair corresponding to the client identifier and the resource identifier; and
appending the hashed version of the identified secret to the entry in the data structure.

4. The computer-implemented method of claim 3, further comprising:
receiving a second HTTP request from the client to access the resource;
identifying the secret associated with the second HTTP request;
applying the hashing algorithm to the identified secret to generate the hashed version of the identified secret;
identifying the entry in the data structure for the client-resource pair corresponding to the client identifier and the resource identifier; and
incrementing a counter associated with the entry in the data structure for the client-resource pair.

5. The computer-implemented method of claim 1, wherein updating the data structure further comprises:
identifying an entry in the data structure for a client-resource pair corresponding to the client identifier and the resource identifier of the first HTTP request; and
updating a timestamp value for the entry with the time of the first HTTP request.

6. The computer-implemented method of claim 1, further comprising:
receiving, from a customer device, configuration data defining a policy associated with secrets for accessing the resource;
determining that the secret has been in use for longer than a maximum time limit established in the policy; and
transmitting a notification message in response to determining that the secret has been in use for longer than the maximum time limit established in the policy.

7. The computer-implemented method of claim 1, wherein the history of the requests for the resources by the clients includes a list of client-resource pairs with least recent secret rotations.

8. A non-transitory machine-readable storage medium that provides instructions that, if executed by a processor, will cause said processor to perform operations comprising, comprising:
receiving a first HTTP request from a client to access a resource;
identifying a secret associated with the first HTTP request;
applying a hashing algorithm to the identified secret to generate a hashed version of the identified secret;
updating a data structure with a client identifier associated with the first HTTP request, a resource identifier associated with the resource, the hashed version of the identified secret, and a time of the first HTTP request; and
generating a dashboard interface based on data stored in the data structure, the dashboard interface displaying a history of requests for resources by clients.

9. The non-transitory machine-readable storage medium of claim 8, wherein identifying the secret associated with the first HTTP request comprises:
performing a pattern recognition on attributes of the first HTTP request, the attributes including an authorization header.

10. The non-transitory machine-readable storage medium of claim 8, wherein updating the data structure further comprises:
generating an entry in the data structure for a client-resource pair corresponding to the client identifier and the resource identifier; and
appending the hashed version of the identified secret to the entry in the data structure.

11. The non-transitory machine-readable storage medium of claim 10, wherein the operations further comprise:
receiving a second HTTP request from the client to access the resource;
identifying the secret associated with the second HTTP request;
applying the hashing algorithm to the identified secret to generate the hashed version of the identified secret;
identifying the entry in the data structure for the client-resource pair corresponding to the client identifier and the resource identifier; and
incrementing a counter associated with the entry in the data structure for the client-resource pair.

12. The non-transitory machine-readable storage medium of claim 8, wherein updating the data structure further comprises:
identifying an entry in the data structure for a client-resource pair corresponding to the client identifier and the resource identifier of the first HTTP request; and
updating a timestamp value for the entry with the time of the first HTTP request.

13. The non-transitory machine-readable storage medium of claim 8, wherein the operations further comprise:
receiving, from a customer device, configuration data defining a policy associated with secrets for accessing the resource;
determining that the secret has been in use for longer than a maximum time limit established in the policy; and
transmitting a notification message in response to determining that the secret has been in use for longer than the maximum time limit established in the policy.

14. The non-transitory machine-readable storage medium of claim 8, wherein the history of the requests for the resources by the clients includes a list of client-resource pairs with least recent secret rotations.

15. A server, comprising:
a processor; and
a non-transitory machine-readable storage medium that provides instructions that, if executed by the processor, will cause the server to perform operations including:
receiving a first HTTP request from a client to access a resource;
identifying a secret associated with the first HTTP request;
applying a hashing algorithm to the identified secret to generate a hashed version of the identified secret;
updating a data structure with a client identifier associated with the first HTTP request, a resource identifier associated with the resource, the hashed version of the identified secret, and a time of the first HTTP request; and
generating a dashboard interface based on data stored in the data structure, the dashboard interface displaying a history of requests for resources by clients.

16. The server of claim 15, wherein identifying the secret associated with the first HTTP request comprises:
performing a pattern recognition on attributes of the first HTTP request, the attributes including an authorization header.

17. The server of claim 15, wherein updating the data structure further comprises:
generating an entry in the data structure for a client-resource pair corresponding to the client identifier and the resource identifier; and
appending the hashed version of the identified secret to the entry in the data structure.

18. The server of claim 17, wherein the operations further comprise:
receiving a second HTTP request from the client to access the resource;
identifying the secret associated with the second HTTP request;
applying the hashing algorithm to the identified secret to generate the hashed version of the identified secret;
identifying the entry in the data structure for the client-resource pair corresponding to the client identifier and the resource identifier; and
incrementing a counter associated with the entry in the data structure for the client-resource pair.

19. The server of claim 15, wherein updating the data structure further comprises:
identifying an entry in the data structure for a client-resource pair corresponding to the client identifier and the resource identifier of the first HTTP request; and
updating a timestamp value for the entry with the time of the first HTTP request.

20. The server of claim 15, wherein the operations further comprise:
receiving, from a customer device, configuration data defining a policy associated with secrets for accessing the resource;
determining that the secret has been in use for longer than a maximum time limit established in the policy; and
transmitting a notification message in response to determining that the secret has been in use for longer than the maximum time limit established in the policy.

21. The server of claim 15, wherein the history of the requests for the resources by the clients includes a list of client-resource pairs with least recent secret rotations.
